(19) United States
(12) Patent Application Publication
(10) Pub. No.: US 2025/0296434 A1
(43) Pub. Date: Sep. 25, 2025

(54) LEAKAGE DIAGNOSIS METHOD AND LEAKAGE DIAGNOSIS SYSTEM FOR A TANK OF A VEHICLE

(71) Applicant: Thomas Magnete GmbH, Herdorf (DE)

(72) Inventors: Olaf OHLIGSCHLÄGER, Grüinebach (DE); Edwin KREUZBERG, Daaden (DE); Thomas FABIG, Nauroth (DE)

(21) Appl. No.: 18/860,468

(22) PCT Filed: Apr. 24, 2023
(86) PCT No.: PCT/EP2023/060562

§ 371 Date: Oct. 25, 2024

(30) Foreign Application Priority Data
Apr. 28, 2022 (DE) 102022 110 336.6

(51) Int. Cl. B60K 15/035; F04B 49/06; F04B 49/08; F04B 51/00; G01M 3/32

(52) U.S. Cl. CPC B60K 15/03519; F04B 49/065; F04B 49/08; F04B 51/00; G01M 3/3236

(57) ABSTRACT

The system relates to a leakage diagnosis system and method for a tank of a vehicle, comprising at least one first connection point and a second connection point, which are each designed to be connected to the tank or to be open to an environment, at least one diaphragm pump which is designed for conveying fluid from the first connection point to the second connection point, at least one ventilation valve which is connected parallel to the diaphragm pump between the first connection point and the second connection point and which is designed to be switched into a first position in which the first connection point and the second connection point are fluidically connected, and into a second position which prevents a fluid flow at least from the second connection point to the first connection point, and at least one evaluation unit which is designed to operate the diaphragm pump, to switch the ventilation valve into the second position and to determine a pressure, in particular a pressure curve, in the connected tank, in order to deduce the existence of a leakage in the tank from the pressure, in particular the pressure curve.

### CROSS-REFERENCE TO RELATED APPLICATIONS

This application is a National Stage of International Application No. PCT/EP2023/060562, filed Apr. 24, 2023, which claims the benefit of and priority to German Patent Application DE 102022110336.6, filed Apr. 28, 2022. The entire disclosures of the above applications are incorporated by reference herein.

### FIELD

The invention relates to a leakage diagnosis system for a tank of a vehicle and a leakage diagnosis method for a tank of a vehicle by the leakage diagnosis system. The invention also relates to a vehicle which has a tank and the leakage diagnosis system.

### BACKGROUND

This section provides background information related to the present disclosure which is not necessarily prior art.

Current leakage diagnosis systems for leakage diagnosis are used in vehicle fuel tanks, among other things. Here, a pressure difference of the tank pressure to the ambient pressure is built up and a leakage in the tank is inferred from the tank pressure over time. A vane pump is used to build up a pressure difference between the tank pressure and the ambient pressure. The vane pump is operated until a predetermined pressure is reached in the tank. Due to the leakage of the vane pump caused by the design principle, when the vane pump is at a standstill, the fluid flows out of the tank through the vane pump. In order to prevent such an outflow, which would falsify a leakage diagnosis of the tank, the vane pump continues to operate even during the leakage diagnosis. This results in pressure pulsations in the tank, which make leakage detection in the tank more difficult. In addition, the prior art vane pump is susceptible to dirt and wear due to the gap between the vane cells and the fixed housing. As the vane pump ages, its delivery rate decreases, which increases the time required to build up pressure in the connected tank. In addition, vane pumps are limited in their delivery capacity and cannot be used effectively to build up pressure in large tanks.

### SUMMARY

This section provides a general summary of the disclosure, and is not a comprehensive disclosure of its full scope or all of its features.

It is the object of the invention to provide a leakage diagnosis system for a tank of a vehicle which is less susceptible to contamination and wear and can also bring larger tanks to a desired pressure in less time, and to provide a method for leakage diagnosis for a tank of a vehicle with this improved leakage diagnosis system.

This object is achieved by a leakage diagnosis system that comprises at least a first connection point and a second connection point, a diaphragm pump, a ventilation valve and an evaluation unit. The first connection point and the second connection point are each designed to be connected to a tank, for example a fuel tank of a vehicle or to be open to the environment. For example, a tank can be connected to one of the two connection points, and the other connection point, to which the tank is not connected, can be open to the environment. The diaphragm pump is connected between the first connection point and the second connection point and is designed to convey a fluid from the first connection point to the second connection point. Thus, the diaphragm pump is designed to generate a negative pressure in a tank connected to the first connection point by conveying fluid from the first connection point to the second connection point, or to generate an overpressure in a tank connected to the second connection point. Through their design principle, a diaphragm pump has fewer wearing parts than a vane pump and is also less susceptible to contamination, resulting in slower ageing. In addition, diaphragm pumps have higher delivery rates, which allow larger tanks to be brought to the desired pressure in a shorter time than is possible using a vane pump. The ventilation valve is connected parallel to the diaphragm pump between the first connection point and the second connection point and has at least one first position and at least one second position. In the first position of the ventilation valve, the first connection point and the second connection point are fluidically connected to each other, so that fluids can flow in both directions between the first connection point and the second connection point through the ventilation valve. In the second position of the ventilation valve, at least one fluid flow from the second connection point to the first connection point is prevented by the ventilation valve. In particular, a fluid flow between the first connection point and the second connection point is completely prevented by the ventilation valve in the second position. The ventilation valve is designed in such a way that it can be switched between the first position and the second position, so that it is possible to switch between a free flow of fluid between the first connection point and the second connection point in both directions via the ventilation valve and prevent the flow of fluid at least from the second connection point to the first connection point by the ventilation valve. The leakage diagnosis system can preferably be used to vent the tank. This ensures that venting can be guaranteed at all times and, in particular, is only interrupted during leakage diagnosis. The evaluation unit is designed to operate the diaphragm pump and thus enable a fluid flow from the first connection point to the second connection point by means of the diaphragm pump. The evaluation unit is also designed to move the ventilation valve from its first position to its second position and thus prevent the flow of fluid at least from the second connection point through the ventilation valve to the first connection point. As a result, fluid can only flow through the ventilation valve from the first connection point to the second connection point. The evaluation unit is also designed to measure a pressure, in particular a pressure curve of a tank connected to the first connection point or the second connection point and to draw conclusions about the presence of a leakage in the connected tank from the determined pressure, in particular from the determined pressure curve. Through the supply of fluid, through the operation of the diaphragm pump, the tank can be brought to a desired pressure. The pressure difference between the pressure in the tank and the pressure in the environment results in a fluid flow between the tank and the environment if there is a leakage. The resulting change in pressure in the tank over time can be used to infer the presence of a leakage in the tank. This pressure curve over time in the tank can be compared, for example, with pressure curves of the tank for example previously experimentally determined over time for different leakage magnitudes of the tank in order to draw conclusions about the magnitude of the leakage in the tank.

In an embodiment, the leakage diagnosis system comprises at least one first pump valve and at least one second pump valve. Here, the first pump valve is connected in series to the diaphragm pump between the first connection point and the diaphragm pump and the second pump valve is connected in series to the diaphragm pump between the diaphragm pump and the second connection point. The first pump valve is designed so that a fluidic connection exists between the first connection point and the diaphragm pump during an intake process of the diaphragm pump and during a compression process of the diaphragm pump there is no fluidic connection from the diaphragm pump to the first connection point. The second pump valve is designed so that during an intake process of the diaphragm pump there is no fluidic connection between the second connection point and the diaphragm pump and during a compression process of the diaphragm pump there is a fluidic connection between the diaphragm pump and the second connection point. As a result, the leakage diagnosis system is designed so that fluids flow into the diaphragm pump from the first connection point and not from the second connection point during an intake process of the diaphragm pump and flow from the diaphragm pump to the second connection point and not to the first connection point by way of a compression process. The leakage diagnosis system is therefore designed, at a tank connected to the first connection point, to increase a negative pressure in the connected tank with each intake process of the diaphragm pump and to increase an overpressure in the connected tank in a tank connected to the second connection side with each compression process of the diaphragm pump. This embodiment also prevents a fluid connection between the second connection point and the first connection point through the diaphragm pump.

In a further embodiment of the leakage diagnosis system, the first pump valve and the second pump valve are non-return valves, in particular umbrella valves. The first non-return valve and the second non-return valve are aligned in the same direction and allow fluid to flow from the first connection point to the diaphragm pump and from the diaphragm pump to the second connection point, so that there is no free flow of fluid between the second connection point and the first connection point via the diaphragm pump. The leakage diagnosis system is therefore set up to convey fluids in only one direction through the diaphragm pump, from the first connection point to the second connection point. The leakage diagnosis system is designed to prevent a free flow of fluid from the second connection point to the first connection point through the diaphragm pump. The first pump valve and the second pump valve are each connected to both sides of a diaphragm of the diaphragm pump in order to enable continuous fluid delivery through the diaphragm pump.

In a further embodiment of the leakage diagnosis system, the ventilation valve is held in its first position by an elastic restoring force of a spring and can be moved to its second position by an electromagnet. The ventilation valve is designed in such a way that the electromagnet can act against the elastic restoring force of the spring when energized and can transfer the ventilation valve from the first position to the second position and hold it in the second position. Without energization, the electromagnet cannot act against the restoring force of the spring, so that the spring transfers the ventilation valve from the first position to the second position. The electromagnet can be designed so that it can be controlled by the evaluation unit. In particular, the electromagnet can be designed in such a way that it can be energized during operation of the diaphragm pump and the duration of the leakage diagnosis and closes the ventilation valve so that no pressure equalization can take place via the ventilation valve between the second connection point and the first connection point for the duration of the leakage diagnosis. If no leakage diagnosis takes place, the ventilation valve is held open by the restoring force of the spring. As no actuation or energization is required for this first position of the ventilation valve, venting of the tank is guaranteed at any time.

In a further embodiment, the leakage diagnosis system comprises an electric motor, an eccentric and a connecting rod. Here, the eccentric is connected to the electric motor and one end of the connecting rod is connected to the eccentric. The diaphragm of the diaphragm pump is connected to the other end of the connecting rod, which is not connected to the eccentric. These elements of the leakage diagnosis system are designed in such a way that the operation of the electric motor causes a stroke movement of the diaphragm of the diaphragm pump. This stroke movement of the diaphragm of the diaphragm pump results in an intake process or a compression process and thus to an overpressure or a negative pressure in a tank connected to the first connection point or second connection point.

The leakage diagnosis system has at least one pressure sensor that is fluidically connected to the first connection point or the second connection point. As a result, the pressure sensor is designed to measure the pressure of a tank connected to the first connection point or the second connection point. The pressure sensor is connected to the evaluation unit. This allows the pressure, in particular the pressure curve, in the tank to be easily recorded by the evaluation unit. In particular, the at least one pressure sensor between the diaphragm pump and the first connection point or the second connection point is fluidically connected to the first connection point or the second connection point. This allows the leakage diagnosis system to be as compact as possible.

The leakage diagnosis system has at least one first pressure sensor and a second pressure sensor. Here, the first pressure sensor is fluidically connected to the first connection point and the second pressure sensor is fluidically connected to the second connection point in order to detect the pressure of a tank connected to the first connection point or second connection point and a pressure in the environment. This makes it easy to determine an overpressure or negative pressure in the tank compared to the environment by the evaluation unit. This also makes it possible to determine both the presence of a leakage in the tank and the magnitude of a leakage by the evaluation unit. For this purpose, for example, after setting a desired pressure in the tank, the further pressure curve over time in the tank can be recorded by the pressure sensor and compared by the evaluation unit with stored pressure curves over time, taking into account the ambient pressure. This provides a particularly efficient and precise leakage diagnosis.

The evaluation unit is set up to detect electrical signals, in particular a current consumption, of the diaphragm pump and, by the detected electrical signals, to determine the pressure, in particular the pressure curve, in a tank connected to the first connection point or the second connection point. This makes it possible, for example, to determine a pressure, in particular a pressure curve, of a tank connected to the first connection point or second connection point without the need for a pressure sensor. As a result, the material costs and the installation costs for a pressure sensor can be saved. In addition, the possible elimination of a pressure sensor allows a more compact design of the leakage diagnosis system.

The pressure, in particular the pressure curve, is determined from a current value recorded or consumed by the pump and/or a consumed power at a known nominal voltage of the diaphragm pump or its time curves. If the fluid delivery line of the diaphragm pump is known, the determined performance of the diaphragm pump can be used to determine the set pressure.

Alternatively, a table with experimentally determined current values, in particular current curves, at different pressures, in particular pressure curves, of a tank connected to the first connection point or second connection point can be stored. From the comparison of the current value determined by the evaluation unit, in particular a flow curve, with such a stored table, the pressure, in particular the pressure curve, of the fluid in a tank connected to the first or second connection point can be determined.

The system is also achieved by a leakage diagnosis method for a tank, in particular a fuel tank, of a vehicle by a leakage diagnosis system. Here, the leakage diagnosis system comprises at least a first connection point and a second connection point, a diaphragm pump and a ventilation valve. The first connection point and the second connection point are designed to be connected to a tank or to be open to the environment. The diaphragm pump is arranged between the first connection point and the second connection point, fluidically connected to both connection points and designed to convey fluid between the first connection point and the second connection point. The ventilation valve is connected parallel to the diaphragm pump between the first connection point and the second connection point and is designed to be switched between a first position and a second position. In the first position, the ventilation valve enables a fluidic connection between the first connection point and the second connection point. This allows fluid to flow in both directions through the ventilation valve. In the second position, the ventilation valve prevents fluid flow between the second connection point and the first connection point. The leakage diagnosis method is carried out as follows. In a first method step, the ventilation valve is switched into the second position. This prevents the flow of fluid through the ventilation valve from the second connection point to the first connection point. In a second method step, the diaphragm pump is operated in order to generate an overpressure or a negative pressure in a tank connected to the first connection point or second connection point. In a third method step, a pressure, in particular a pressure curve, is determined in the connected tank in order to draw conclusions about the presence of a leakage in the tank.

The system also relates to a vehicle which has a tank and the leakage diagnosis system according to the previous embodiments, wherein the tank is fluidically connected to the first connection point or the second connection point of the leakage diagnosis system.

In particular, the vehicle can be a motor vehicle.

In particular, the evaluation unit can comprise or be a processor such as a CPU/GPU/FPGA. In particular, the evaluation unit can be an engine control unit of the vehicle. Alternatively or additionally, the evaluation unit can comprise a transceiver by means of which commands for operation and/or determined results of the evaluation unit can be transmitted wirelessly.

Further areas of applicability will become apparent from the description provided herein. The description and specific examples in this summary are intended for purposes of illustration only and are not intended to limit the scope of the present disclosure.

### DRAWINGS

Further details, advantages and features of the present invention are found in the following description of exemplary embodiments with reference to the drawing, in which:

FIG. 1 shows a sketch of a vehicle with a leakage diagnosis system according to an embodiment of the present invention;

FIG. 2 shows a sketch of the leakage diagnosis system according to the embodiment of the present invention;

FIG. 3 shows a sketch illustrating an exemplary structure of a diaphragm pump of the leakage diagnosis system according to the embodiment of the present invention; and

FIG. 4 shows a block diagram of a method for leakage diagnosis according to an embodiment of the present invention.

Corresponding reference numerals indicate corresponding parts throughout the several views of the drawings.

### DETAILED DESCRIPTION

Example embodiments will now be described more fully with reference to the accompanying drawings.

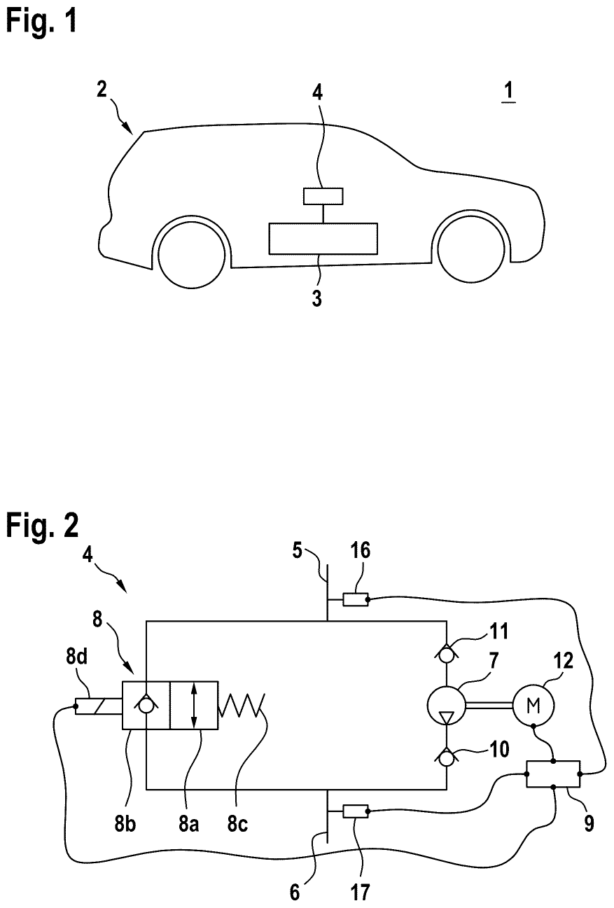

FIG. 1 shows a sketch of a vehicle 2 with a tank 3 for fuel and a leakage diagnosis system 4 according to an embodiment. The reference sign 1 indicates an environment 1, wherein the environment 1 is air (atmosphere).

The leakage diagnosis system 4 can be permanently installed in the vehicle 2. Alternatively, the leakage diagnosis system 4 can be removed from the vehicle 2 non-destructively, wherein one or more connections to the tank 3 can also be detached non-destructively.

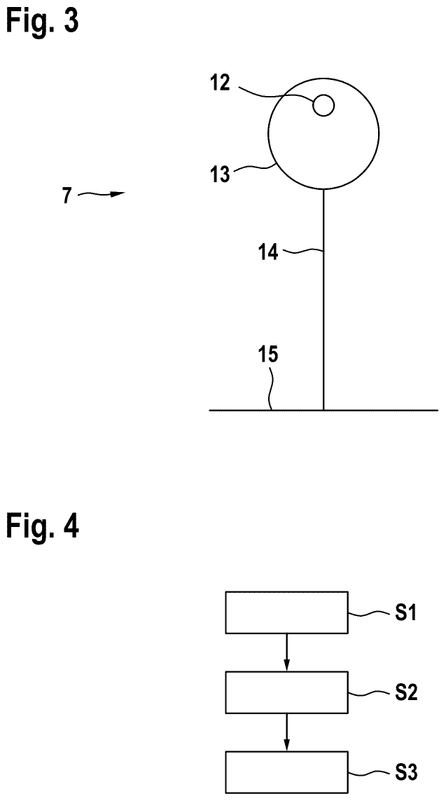

First, an exemplary structure and the functioning of the leakage diagnosis system 4 will be explained with reference to FIGS. 2 and 3. The leakage diagnosis method will be explained with reference to FIG. 4.

FIG. 2 shows a sketch of the leakage diagnosis system 4 according to the embodiment.

The leakage diagnosis system 4 comprises a first connection point 5 and a second connection point 6 as well as a diaphragm pump 7. The diaphragm pump 7 is designed to convey fluid from the first connection point 5 to the second connection point 6.

The first connection point 5 and the second connection point 6 are each set up to be connected to the tank 3 or to be open to the environment 1 (atmospheric air). Which connection point 5, 6 is connected to the tank 3 depends on whether the leakage diagnosis is carried out by negative pressure or overpressure in the tank 3. If the second connection point 6 is connected to the tank 3, the fluid delivery of the diaphragm pump 7 causes an overpressure in the tank 3. If, on the other hand, the first connection point 5 is connected to the tank 3, the fluid delivery of the diaphragm pump 7 causes a negative pressure in the tank 3.

The diaphragm pump 7 has an electric motor 12 or can be driven by an electric motor 12. A first pump valve 10 and a second pump valve 11 are also provided. The first pump valve 10 and the second pump valve 11 are arranged in series with and between the first connection point 5 and the second connection point 6 and are designed as non-return valves. Thus, the pump valves 10, 11 cause the fluid flow of the diaphragm pump 7 to take place in a predetermined direction as follows.

During an intake process of the diaphragm pump 7, there is a fluidic connection between the diaphragm pump 7 and the first connection point 5, but not between the diaphragm pump 7 and the second connection point 6. During a compression process of the diaphragm pump 7, there is a fluidic connection between the diaphragm pump 7 and the second connection point 6, but not between the diaphragm pump 7 and the first connection point 6. This generates a fluid flow from the first connection point 5 to the second connection point 6 by the diaphragm pump 7 via the pump valves 10, 11.

FIG. 3 shows a sketch to explain further details of an exemplary structure of the diaphragm pump 7 of the leakage diagnosis system 4 according to the embodiment.

The electric motor 12 is connected to an eccentric 13. The eccentric 13 is in turn connected to a connecting rod 14. The eccentric 13 converts a rotational force of the electric motor 12 into a linear force, which is transmitted to a diaphragm 15 of the diaphragm pump 7 by the connecting rod 14. This causes a rotation of the electric motor 12, more precisely a shaft of the electric motor 12, not shown, a stroke movement of the diaphragm 15 and thus a compression process or an intake process of the diaphragm pump 7. In principle, a stroke movement of the diaphragm 15 caused by the electromagnet 8d leads to an overpressure (compression process) or to a negative pressure (intake process).

The leakage diagnosis system 4 as shown in FIG. 2 also comprises a ventilation valve 8. The ventilation valve 8 is connected parallel to the diaphragm pump 7 between the first connection point 5 and the second connection point 6 and has two positions 8a, 8b.

In the first position 8a, the ventilation valve 8 is open so that the first connection point 5 and the second connection point 6 are fluidically connected to each other. This allows fluids, in particular air, to flow in both directions between the first connection point 5 and the second connection point 6 through the ventilation valve 8. In the second position 8b, the ventilation valve 8 is closed so that a fluid flow from the second connection point 6 through the ventilation valve 8 to the first connection point 5 is prevented. The ventilation valve 8 can be switched continuously here between the two positions, so that fluid flows can also be only partially prevented, i.e. throttled.

For this purpose, the ventilation valve 8 has an electromagnet 8d and a spring 8c. The spring 8c is designed and arranged here in such a way that it acts against a force generatable by the electromagnet 8d. In other words, a sufficiently high force generated by the electromagnet 8d causes the spring 8c to move, allowing the ventilation valve 8 to be switched between the two positions 8a, 8b. When the electromagnet 8d is not energized, the ventilation valve 8 is in the first position 8a. FIG. 2 shows an energized state of the electromagnet 8d and thus the ventilation valve 8 in the second position 8b.

The fact that the electromagnet 8d can only overcome the spring force of the spring 8c when energized and thus switch the ventilation valve 8 to the second position 8b ensures that, in the event of a malfunction of the ventilation valve 8, it remains in the first position 8a so that ventilation of the tank 3 can be ensured.

The leakage diagnosis system 4 also comprises an evaluation unit 9. The evaluation unit 9 is connected to an electric motor 12 of the diaphragm pump 7 and to the electromagnet 8d of the ventilation valve 8. The evaluation unit 9 is set up to control the diaphragm pump 7 by the electric motor 12 and the ventilation valve 8 by the electromagnet 8d.

The evaluation unit 9 is also connected to a first pressure sensor 16, which detects a pressure at the first connection point 5, and to a second pressure sensor 17, which detects a pressure at the second connection point 6.

As an alternative or in addition to one or both pressure sensors 16, 17, the evaluation unit 9 can determine the pressure from electrical signals, in particular from a current consumption of the diaphragm pump 7. The current consumption correlates with the power of the diaphragm pump 7, particularly for a given nominal voltage, from which the pressure generated by the diaphragm pump 7 can be determined.

The following shows an operation of the leakage diagnosis system 4 for leakage diagnosis on the basis of FIG. 4. FIG. 4 shows a block diagram of a method for leakage diagnosis according to one embodiment.

In a first method step S1, the ventilation valve 8 is switched to the second position 8b. This prevents the flow of fluid through the ventilation valve 8 from the second connection point 6 to the first connection point 5.

In a second method step S2, the diaphragm pump 7 is operated in order to generate an overpressure or a negative pressure in a tank 3 connected to the first connection point 5 or to the second connection point 6. As already explained, the diaphragm pump 7 conveys fluid from the first connection point 5 to the second connection point 6.

In a third method step S3, a pressure, in particular a pressure curve, is determined in the connected to tank 3 in order to draw conclusions about the presence of a leakage in tank 3. As explained above, the pressure can be detected by the pressure sensors 16, 17 and/or by the electrical signals from the diaphragm pump 7.

In particular, the diaphragm pump 7 can be switched off between steps S2 and S3, as the pump valves 10, 11 and the closed ventilation valve 8 prevent a pressure equalization between the first connection point 5 and the second connection point 6. If a falling pressure (overpressure in the tank 3 caused by the diaphragm pump 7) is detected by the pressure sensors 16, 17 during this time, this detection can be used to draw conclusions about a leakage in the tank 3. For this purpose, for example, a pressure curve of the pressure over time can be recorded by the pressure sensors 16, 17 and evaluated by the evaluation unit 9.

Alternatively, the pressure can also be recorded once. In this case, it is assumed that the diaphragm pump 7 (after a predetermined pumping time) has produced a predetermined pressure in the tank 3. Then, after a predetermined waiting time, the pressure in the tank 3 can be detected by at least one of the pressure sensors 16, 17. If the detected pressure deviates from the predetermined pressure produced by the diaphragm pump 7, a leakage in the tank 3 can be inferred. The deviation between the detected pressure and the expected pressure can be compared in particular with experimentally determined values in order to draw conclusions about the presence and magnitude of the leakage. For example, it can be determined that a leakage is only present if the deviation is above a predetermined threshold value in a predetermined period of time, for example to take into account fault tolerances or leakages in the leakage diagnosis system 4.

When using the electrical signals from the diaphragm pump 7 to determine the pressure generated by the diaphragm pump 7, for example the diaphragm pump 7 can be operated constantly between steps S2, S3. If there is a leakage in the tank 3, the current consumption of the diaphragm pump 7 increases to generate the predetermined pressure. In turn, an expected current consumption of the diaphragm pump 7 can be compared with an experimentally determinable setpoint value so that the presence of a leakage can be inferred. A determined fluid delivery rate of the diaphragm pump 7 can also be used to infer the magnitude of the leakage.

The aforementioned steps S1-S3 are carried out in particular by the evaluation unit 9. For this purpose, the evaluation unit 9 can have or be a CPU/GPU/FPGA. Alternatively or additionally, an engine control unit (not shown) of the vehicle 2 can be designed as the aforementioned evaluation unit 9.

In addition to the above written description of the invention, explicit reference is hereby made to the graphic representation of the invention in FIGS. 1 to 4 for its supplementary disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

### LIST OF REFERENCE SIGNS

1 environment
2 vehicle
3 tank
4 leakage diagnosis system
5 first connection point
6 second connection point
7 diaphragm pump
8 ventilation valve
8a first position
8b second position
8c spring
8d electromagnet
9 evaluation unit
10 first pump valve
11 second pump valve
12 electric motor
13 eccentric
14 connecting rod
15 diaphragm
16 first pressure sensor
17 second pressure sensor
S1 first step
S2 second step
S3 third step

1-10. (canceled)

11. A leakage diagnosis system for a tank of a vehicle, comprising:
at least a first connection point and a second connection point, which are each configured to be connected to the tank, or to be open to an environment;
at least one diaphragm pump, configured to convey fluid from the first connection point to the second connection point;
at least one ventilation valve, which is connected in parallel to the diaphragm pump between the first connection point and the second connection point and is configured to be switched to a first position, in which the first connection point and the second connection point are fluidically connected, and to a second position, which prevents a fluid flow at least from the second connection point to the first connection point; and
at least one evaluation unit which is configured to operate the diaphragm pump, to switch the ventilation valve to the second position and to determine a pressure, including a pressure curve, in a tank connected to the first connection point or second connection point, in order to draw conclusions from the pressure, including the pressure curve, as to the presence of a leakage in the tank.

12. The leakage diagnosis system as claimed in claim 11, further comprising a first pump valve arranged in series with the diaphragm pump between the first connection point and the diaphragm pump and a second pump valve is arranged in series with the diaphragm pump between the second connection point and the diaphragm pump, and the first pump valve and the second pump valve are configured such that, during an intake process of the diaphragm pump, there is a fluidic connection between the diaphragm pump and the first connection point but not the second connection point, and in a compression process of the diaphragm pump there is a fluidic connection between the diaphragm pump and the second connection point but not the first connection point.

13. The leakage diagnosis system as claimed in claim 12, wherein the first pump valve and the second pump valve are non-return umbrella valves.

14. The leakage diagnosis system as claimed in claim 11, wherein the ventilation valve is held by a spring in the first position and can be transferred to the second position by an electromagnet, which acts against the spring force when energized.

15. The leakage diagnosis system as claimed in claim 11, further comprising an electric motor to which an eccentric is connected, on which an end of a connecting rod is mounted that at its other end is secured to the diaphragm of the diaphragm pump in order to enable a stroke movement of the diaphragm of the diaphragm pump during operation of the electric motor.

16. The leakage diagnosis system as claimed in claim 11, further comprising at least one pressure sensor which is fluidically connected to the first connection point or the second connection point in order to measure a pressure in a tank connected to the first connection point or the second connection point.

17. The leakage diagnosis system as claimed in claim 16, where the at least one first pressure sensor is fluidically connected to the first connection point and one second pressure sensor is fluidically connected to the second connection point in order to measure a pressure in the tank and a pressure in the environment.

18. The leakage diagnosis system as claimed in claim 11, wherein the at least one evaluation unit is set up to evaluate electrical signals, including a current consumption, of the diaphragm pump and to use the electrical signals to determine the pressure, including the pressure curve, in a tank connected to the first connection point or second connection point.

19. A vehicle comprising a tank and the leakage diagnosis system as claimed in claim 11, wherein the tank is fluidically connected to the first connection point or the second connection point of the leakage diagnosis system.

20. A leakage diagnosis method for a tank of a vehicle by a leakage diagnosis system, comprising at least a first connection point and a second connection point, each of which is designed to be connected to the tank or to be open to an environment, at least one diaphragm pump which is configured to convey fluid from the first connection side to the second connection side, and at least one ventilation valve which is connected in parallel with the diaphragm pump between the first connection point and the second connection point and is configured to be switched in a first position, in which the first connection point and the second connection point are fluidically connected, and a second position, which prevents a fluid flow at least from the second connection point to the first connection point, wherein the method comprises:
a first step (S1), in which the ventilation valve is switched to the second position;
a second step (S2), in which the diaphragm pump is operated to generate an overpressure or a negative pressure in a tank connected to the first connection point or second connection point; and
a third step (S3), in which a pressure, including a pressure curve, is determined in the tank in order to draw conclusions about the presence of a leakage in the connected tank.
